(19) United States
(12) Patent Application Publication
(10) Pub. No.: US 2020/0326200 A1
(43) Pub. Date: Oct. 15, 2020

(54) SCHEDULE MANAGEMENT SYSTEM

(71) Applicant: DENSO CORPORATION, Kariya-city (JP)

(72) Inventors: Syota MIZOGUCHI, Kariya-city (JP); Takuya HASEGAWA, Kariya-city (JP)

(21) Appl. No.: 16/829,019

(22) Filed: Mar. 25, 2020

(30) Foreign Application Priority Data
Apr. 9, 2019 (JP) 2019-074071

(51) Int. Cl. G01C 21/36; G01C 21/34; G06Q 10/02; G06Q 50/30

(52) U.S. Cl. CPC G01C 21/3641; G06Q 50/30; G06Q 10/02; G01C 21/3423

(57) ABSTRACT

A schedule management system includes: a user information storage portion that stores user information corresponding to identification information to identify a user, wherein the user information includes method information showing an available transport method among multiple transport methods; a request acquisition portion that acquires event information and the identification information, wherein the event information includes a departure place, a destination, and a time to arrive at the destination; a route search portion that generates one or more route candidates by performing a route search; and a result provision portion that provides a search result from the route search portion.

### CROSS REFERENCE TO RELATED APPLICATION

The present application claims the benefit of priority from Japanese Patent Application No. 2019-074071 filed on Apr. 9, 2019. The entire disclosure of the above application is incorporated herein by reference.

### TECHNICAL FIELD

The present disclosure relates to the technology that supports activities of employees.

### BACKGROUND

As a comparative example, a schedule management system in which a center searches for a route to a destination from a departure place according to a schedule such as a business tour, calculates an estimated time of departure, a transport method, and an estimated time of arrival, and notifies these to a terminal has been proposed. When the schedule is estimated to be unsuccessfully completed due to a change in the traffic situation, the system calculates a new estimated time of departure or arrival and notifies it to the terminal.

### SUMMARY

A schedule management system may include: a user information storage portion that may store user information corresponding to identification information to identify a user, wherein the user information includes method information showing an available transport method among multiple transport methods; a request acquisition portion that may acquire event information and the identification information, wherein the event information includes a departure place, a destination, and a time to arrive at the destination; a route search portion that may generate one or more route candidates by performing a route search: and a result provision portion that may provide a search result from the route search portion.

### BRIEF DESCRIPTION OF DRAWINGS

The features and advantages of the present disclosure will become more apparent from the following detailed description made with reference to the accompanying drawings. In the drawings:

FIG. 1 is a block diagram showing a configuration of the schedule management system;

FIG. 2 is an explanatory diagram showing contents of user information;

FIG. 3 is a flowchart showing a scheduler process performed by a terminal processing portion;

FIG. 4 is an explanatory diagram showing a schedule table displayed according to schedule information;

FIG. 5 is an explanatory diagram showing a new entry screen for event information;

FIG. 6 shows an event screen to display information about a specified event;

FIG. 7 shows a candidate provision screen to display multiple route candidates as a result of a route search;

FIG. 8 is a flowchart showing a schedule setting process performed by a center processing portion;

FIG. 9 is a flowchart showing a reservation monitoring process performed by the center processing portion;

FIG. 10 is an explanatory diagram showing a map display when a route is changed;

FIG. 11 is an explanatory diagram showing a text display regarding route information when a route is changed;

FIG. 12 is a flowchart showing a route search process performed by the center processing portion according to a second embodiment;

FIG. 13 is an explanatory diagram regarding an operation to add an event to the schedule;

FIG. 14 is an explanatory diagram showing a display screen when an external later schedule exists and an event is added;

FIG. 15 is a flowchart showing the route search process performed by the center processing portion based on a current location as a departure place according to a third embodiment;

FIG. 16 is a flowchart showing a terminal-side process performed by a terminal processing portion of a terminal device mounted on a vehicle according to a fourth embodiment; and

FIG. 17 is a flowchart showing a center-side process performed by the center processing portion according to the fourth embodiment.

### DETAILED DESCRIPTION

Along with the popularization of carsharing, there is an increase in options for the transport method available to the business tour. The business tour is conducted by combining multiple transport methods. As a result of detailed exploration, however, the inventors found that the schedule management system as the comparative example cannot cope with a situation to use different transport methods.

An increase in options for the transport method may force a transport method recommended by the company or limit available transport methods to individuals. In such a situation, there is a need to confirm the availability of the transport method for each individual and set and change a transfer route according to the schedule, requiring great care.

One example of the present disclosure provides the technology of easily settling and changing a scheduled transfer route.

According to one example embodiment, a schedule management system may include: a user information storage portion that may store user information corresponding to identification information to identify a user, wherein the user information may include method information showing an available transport method among multiple transport methods prepared in advance; a request acquisition portion that may acquire event information and the identification information, wherein the event information may include a departure place, a destination, and a time to arrive at the destination; a route search portion that may generate one or more route candidates by performing a route search using the available transport method in the user information stored in the user information storage portion in accordance with the event information and the identification information acquired by the request acquisition portion; and a result provision portion that may provide a search result from the route search portion.

According to another example embodiment, a schedule management system may include: one or more processors; and a memory that may store user information corresponding to identification information to identify a user, wherein the user information may include method information showing an available transport method among multiple transport methods prepared in advance, and coupled to the one or more processors and storing program instructions that when executed by the one or more processors may cause the one or more processors to at least: acquire event information and the identification information, wherein the event information may include a departure place, a destination, and a time to arrive at the destination; generate one or more route candidates by performing a route search using the available transport method in the user information in accordance with the event information and the acquired identification information; and provide a search result from the route search portion.

Furthermore, according to another example embodiment, a schedule management system may include: a terminal that may include one or more first processors; a first memory coupled to the one or more first processors and storing program instructions that when executed by the one or more first processors may cause the one or more first processors to at least: acquire event information and identification information to identify a user, wherein the event information includes a departure place, a destination, and a time to arrive at the destination; a center that may include: one or more second processors; and a second memory that may store user information corresponding to the identification information, wherein the user information includes method information showing an available transport method among multiple transport methods prepared in advance, and coupled to the one or more second processors and storing program instructions that when executed by the one or more second processors may cause the one or more second processors to at least: generate one or more route candidates by performing a route search using the available transport method in the user information in accordance with the event information and the acquired identification information: and transmit a search result obtained by the performed route search to the terminal device. The terminal further includes a display device configured to display the search result.

The above-described configuration performs a route search by using a transport method that is shown in the user information and is available for a requesting user. It may be possible to easily set an appropriate transfer route to the destination without making the user aware of which transport methods are available.

Hereinafter, embodiments of the present disclosure will be described with reference to the accompanying drawings.

### 1. First Embodiment

### 1-1 Configuration

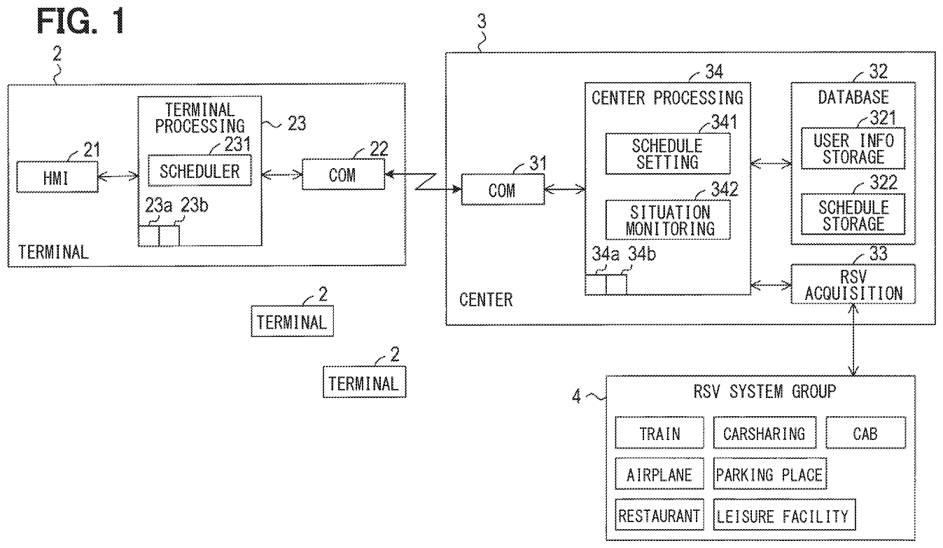

A schedule management system 1 as shown in FIG. 1 includes multiple terminal devices 2 and a center device 3. The center device 3 is installed in a company, for example. The terminal device 2 may include a personal computer connected to the center device 3 via an intra-office LAN or a mobile terminal such as a smartphone or a tablet computer connected to the center device 3 via a wireless communication line. LAN is an abbreviation for local area network. In the drawings, a term of “INFO” corresponds to a term of “information”, a term of “COM” corresponds to a term of “communication”, and a term of “RSV” corresponds to a term of “reservation”.

The terminal device 2 includes an HMI portion 21, a communication portion 22, and a terminal processing portion 23. HMI is an abbreviation for Human Machine Interface.

The HMI portion 21 includes an input device such as a keyboard and a touch panel, a display device such as a liquid crystal panel, and an audio device such as a speaker and a microphone. The input device included in the HMI portion 21 is used to enter various types of information needed to register a schedule and an instruction needed to set or change a transfer route used to move to a destination registered in the schedule. The display device included in the HMI portion 21 displays an input screen used to enter information and displays a result screen to display the results of a process performed based on the entered information. The audio device included in the HMI portion 21 gives audible notifications to a user of the terminal device 2 by using voice and alarm sound.

The communication portion 22 communicates with the center device 3 via a wireless communication line or the intra-office LAN.

The terminal processing portion 23 includes a microcomputer comprised of a CPU 23a and semiconductor memory (hereinafter described as memory 23b) such as RAM, ROM, and flash memory. The terminal processing portion 23 includes a scheduler 231 as a function implemented based on a program executed by the CPU 23a. The processing contents of the scheduler 231 will be described later.

The center device 3 includes a communication portion 31, a database 32, a reservation acquisition portion 33, and a center processing portion 34

The communication portion 31 is used for communication with the terminal device 2 via a wireless communication line or an intra-office LAN. The communication portion 31 is also used for communication with a vehicle and a server to provide traffic information as well as the terminal device 2.

The database 32 is comprised of a non-volatile memory capable of rewriting the storage contents and includes a user information storage portion 321 and a schedule storage portion 322.

The user information storage portion 321 stores user information. The user information concerns individual users who use the schedule management system 1. The user information may be set and updated by using the specific terminal device 2 connected to the intra-office LAN.

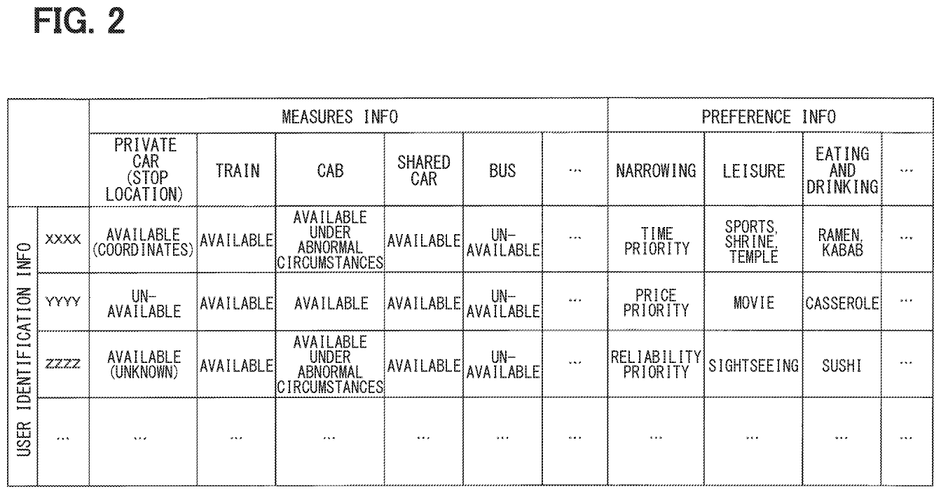

As shown in FIG. 2, the user information contains method information and preference information corresponding to identification information to identify an individual user. The method information concerns a transport method available to the user. The preference information concerns the preferences of the user.

Specifically, for each of the transport methods, the method information represents a state of “available” where the transport method is available, a state of “unavailable” where the transport method is unavailable, or a state of “available under abnormal circumstances” where the transport method is available only under abnormal circumstances. The transport method represented by the method information mainly includes private cars, trains, cabs, carsharing, rental cars, and buses. For example, a cab may be defined to be “available under abnormal circumstances”. Then, the cab can be used only when the private car or the shared car malfunctions or the train is interrupted due to an accident in transit. The definition of abnormal circumstances is not limited to vehicle malfunctions or train interruptions. The method information about private cars also registers the stop location of a private car as well as the information about availability or unavailability. The information about the stop location is acquired from the communication between the center device 3 and the vehicle, for example.

The preference information contains narrowing information representing items to be prioritized in selecting the transport method to set a route to the business tour destination. For example, the narrowing information includes a time priority giving preference to minimal transfer time, a price priority giving preference to a minimal cost, and a reliability priority giving preference to a minimal delay in the time. The preference information may include a preference for leisure in idle time and preference for foods. The leisure includes sports, movie watching, sightseeing, and eating and drinking as a large classification. There may be a middle classification and a small classification to represent more detailed preferences. For example, the sightseeing may include classifications of shrine or temple, museum, and historic site. The sports and movie watching may include classifications representing detailed categories. The eating and drinking may include the large classification of western food and Japanese food and the small classification representing cooking styles such as ramen, kabab, casserole, and sushi.

The schedule storage portion 322 stores schedule information. The schedule information is stored corresponding to user identification information that identifies a user. In the description below, an event signifies each schedule contained in the schedule information. The schedule information contains the name of an event, the date of the event, the place (destination) of the event, the contents of the event, and the method of transportation to and from the event.

The reservation acquisition portion 33 is connected to a reservation system group 4 in the outside and follows instructions from the center processing portion 34 to automatically set, change, and cancel various reservations. The reservation system group 4 contains reservations for transport methods such as train, carsharing, cab, airplane, and parking place, for example. The reservation target may contain at restaurants and various leisure facilities.

The center processing portion 34 includes a microcomputer comprised of a CPU 34a and semiconductor memory (hereinafter described as memory 34b) such as RAM, ROM, and flash memory. The center processing portion 34 includes a schedule setting portion 341 and a situation monitoring portion 342 as functions implemented based on a program executed by the CPU 34a.

### 1-2 Terminal-Side Scheduler Process

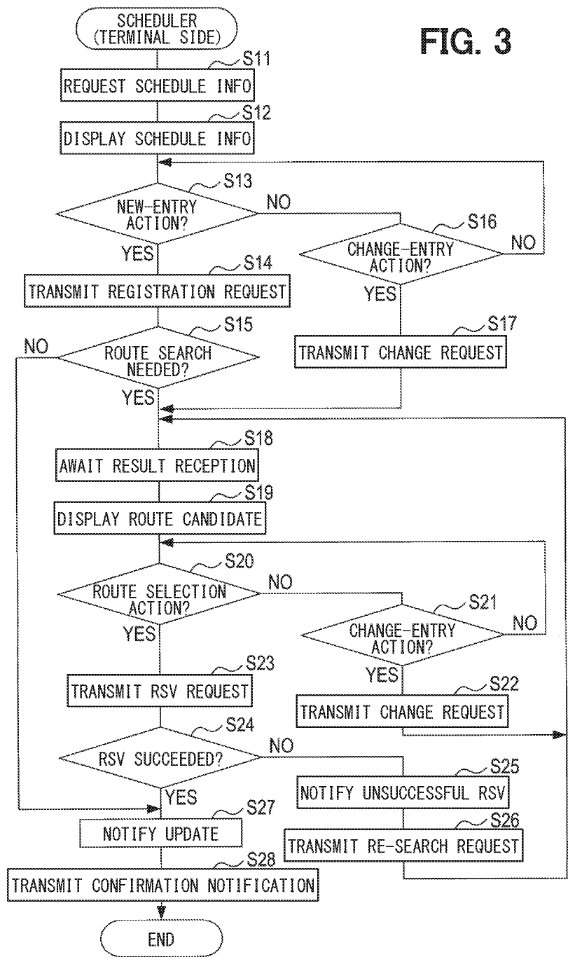

A scheduler process performed by the scheduler 231 of the terminal processing portion 23 will be described with reference to a flowchart in FIG. 3.

The scheduler process starts in response to an action to start the process through the use of the HMI portion 21 of the terminal device 2.

In S11, the terminal processing portion 23 transmits a schedule information request to the center device 3. The schedule information request provides user identification information that identifies a user. When receiving a response from the center device 3, the terminal processing portion 23 advances the process to S12. In the description below, a target user signifies the user identified by the user identification information. The user identification information may be entered from the HMI portion 21 when the scheduler process starts or may be associated with the terminal device 2 in advance.

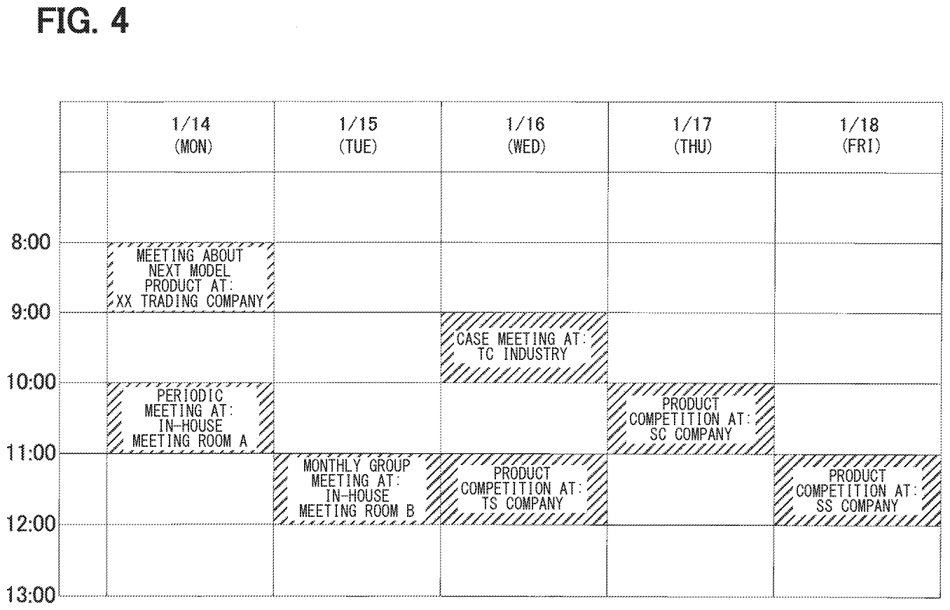

In S12, the terminal processing portion 23 displays a schedule table on the screen of the HMI portion 21 based on the schedule information about the target user included in the response from the center device 3. As shown in FIG. 4, the schedule table chronologically organizes registered events on a date basis.

In S13, the terminal processing portion 23 determines whether a new-entry action is performed to enter a new event through the use of the HMI portion 21. If it is determined that the new-entry action is performed, the terminal processing portion 23 advances the process to S14. If it is determined that the new-entry action is not performed, the terminal processing portion 23 advances the process to S16.

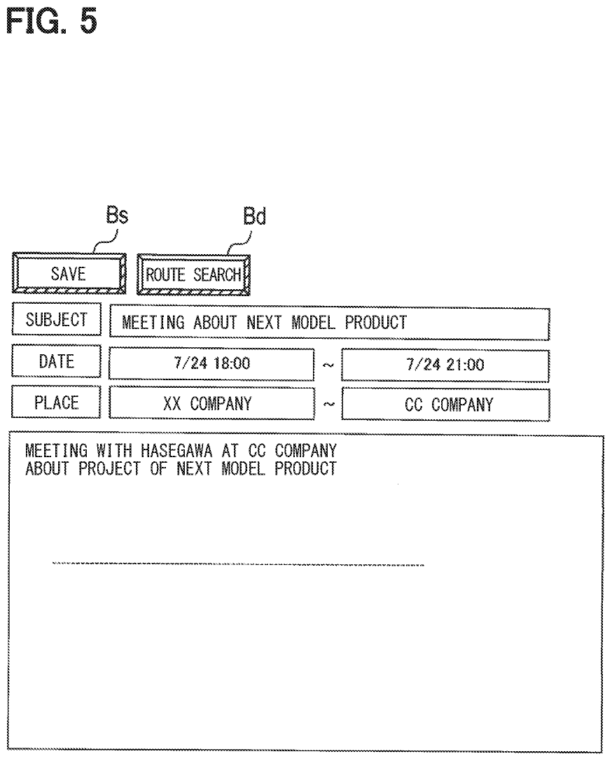

The new-entry action signifies a sequence of actions as follows. According to an instruction entered from the HMI portion 21, a monitor of the HMI portion 21 displays an information input screen (new entry screen) to prompt a user to enter the information. As shown in FIG. 5, for example, the new entry screen contains areas to mainly enter the name of an event, the date and time, the departure place, the destination (place to hold the event), and the contents of the event. The new entry screen provides a save button Bs and a route search button Bd. The terminal processing portion 23 determines that the new-entry action is performed when the information is entered via the HMI portion 21 and route search button Bd is pressed.

In S14, the terminal processing portion 23 transmits a registration request to the center device 3. The registration request contains event information entered by the new-entry action and the user identification information.

In S15, the terminal processing portion 23 determines whether the route search is necessary, based on the event information indicated in the registration request. Specifically, the route search is determined to be unnecessary when the event is to be held in the company. If the route search is necessary, the terminal processing portion 23 advances the process to S18. If the route search is unnecessary, the terminal processing portion 23 awaits a registration notification from the center device 3 and then advances the process to S27.

In S16, the terminal processing portion 23 determines whether a change-entry action is performed via the HMI portion 21 to change the contents of the registered event. If it is determined that the change-entry action is performed, the terminal processing portion 23 advances the process to S17. If it is determined that the change-entry action is not performed, the terminal processing portion 23 returns the process to S13.

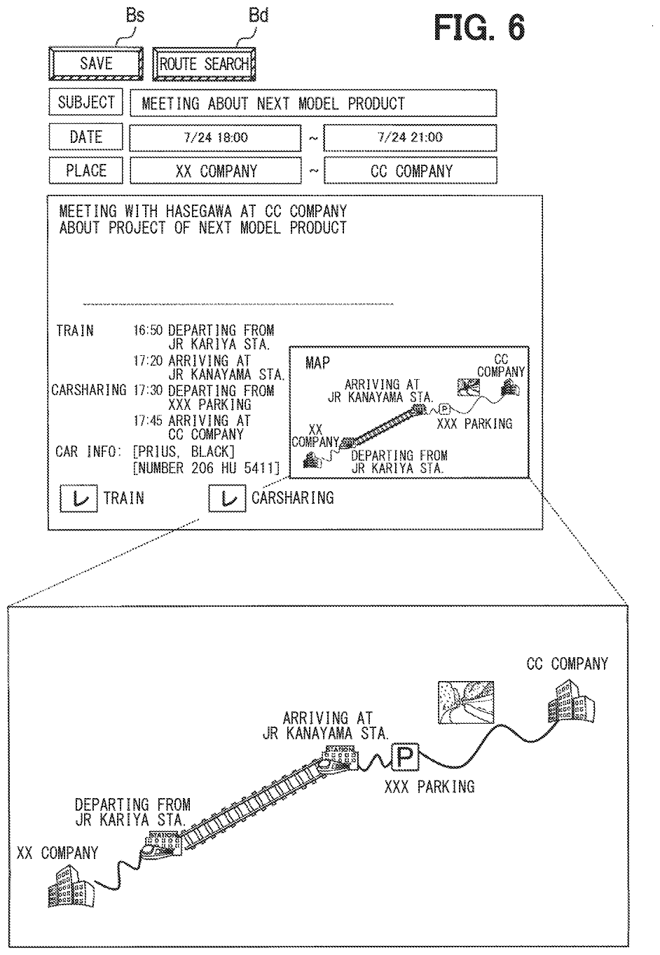

The change-entry action signifies a sequence of actions as follows. For example, the user selects one of the events indicated in the schedule table according to an instruction entered from the HMI portion 21. The monitor of the HMI portion 21 displays an event screen that displays the registered contents of the selected event. As shown in FIG. 6, for example, the event screen shows the method of transfer from the departure place to the destination, a simplified map covering the departure place to the destination, and the transport method used for the transfer in addition to the contents entered from the new entry screen. The transport method to be used is displayed with the corresponding checkbox checked. The user can uncheck the checkbox to instruct that the transport method is not used or the transport method is changed. Entry items in the new entry screen may be changed. The terminal processing portion 23 determines that the change-entry action is performed when the change contents are entered from the HMI portion 21 and the route search button Bd is pressed. In the drawings, a term of “STA” corresponds to a term of “station”.

In S17, the terminal processing portion 23 transmits a change request to the center device 3 and advances the process to S18. The change request contains change information and the user identification information. The change information is entered by the change-entry action.

In S18, the terminal processing portion 23 waits until receiving a response from the center device 3. When receiving the response from the center device 3, the terminal processing portion 23 advances the process to S19.

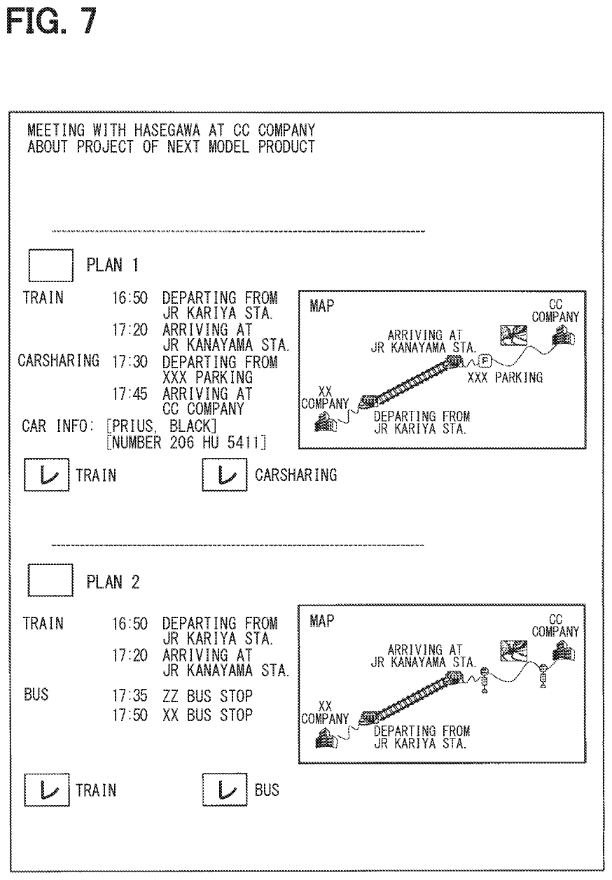

In S19, the terminal processing portion 23 allows the monitor of the HMI portion 21 to display a candidate provision screen that shows multiple pieces of route information contained in the response from the center device 3. Multiple pieces of route information shown in the candidate provision screen result from the route search performed by the center device 3 in accordance with the registration request or the change request. As shown in FIG. 7, the candidate provision screen shows multiple route candidates. Each route candidate is provided with the method of transfer from the departure place to the destination, the simplified map representing a route from the departure place to the destination, and the transport method to be used. Similarly to the change-entry screen, the transport method is accompanied by a checkbox. Each route candidate is also accompanied by a checkbox to select the intended route candidate.

In S20, the terminal processing portion 23 determines whether a route selection action is performed via the HMI portion 21. During the route selection action, a user checks the checkbox corresponding to the intended route candidate on the candidate provision screen and presses the save button Bs. If it is determined that the route selection action is performed, the terminal processing portion 23 advances the process to S23. If it is determined that the route selection action is not performed, the terminal processing portion 23 advances the process to S21.

In S21, the terminal processing portion 23 determines whether the change-entry action is performed via the HMI portion 21. The change-entry action is already described in S16. If it is determined that the change-entry action is performed, the terminal processing portion 23 advances the process to S22. If it is determined that the change-entry action is not performed, the terminal processing portion 23 returns the process to S20.

Similarly to the process in S17, in S22, the terminal processing portion 23 transmits a change request to the center device 3 and returns the process to S18.

In S23, the terminal processing portion 23 transmits a reservation request to the center device 3 and waits until receiving a response to the reservation request from the center device 3. When receiving the response, the terminal processing portion 23 advances the process to S23. The reservation request contains a selected route and the user identification information. The selected route shows a route candidate selected by the route selection action.

In S24, the terminal processing portion 23 confirms the contents of the response from the center device 3 and determines whether the selected route is successfully reserved. If the response shows an information update notification, the terminal processing portion 23 determines the reservation to be successful and advances the process to S27. If the response shows an unsuccessful reservation notification, the terminal processing portion 23 determines the reservation to be unsuccessful and advances the process to S25.

In S25, the terminal processing portion 23 allows the HMI portion 21 to visually or audibly notify the user that the reservation fails.

In S26, the terminal processing portion 23 transmits a re-search request to the center device 3 in response to a press of the route search button Bd displayed on the monitor of the HMI portion 21 and returns the process to S18.

In S27, the terminal processing portion 23 allows the HMI portion 21 to visually or audibly notify the user that the schedule is updated (newly registered or changed).

In S28, the terminal processing portion 23 transmits a confirmation notification to the center device 3 and ends the process. The confirmation notification shows that the schedule update is confirmed.

No action may be confirmed within a predetermined permissible time in S13, S16, S20, and S21. In such a case, the process may be forcibly ended.

In the scheduler process, the processes in S11 to S14 correspond to a request acquisition portion, the processes in S16 and S17 correspond to a change acquisition portion, the processes in S18 and S19 correspond to a result provision portion, and the processes in S20 to S23 correspond to a selection portion. The terminal processing portion 23 may correspond to the request acquisition portion, the change acquisition portion, the result provision portion, and the selection portion.

### 1-3 Center-Side Process

The center processing portion 34 performs a user information process and an information provision process as well as a schedule setting process and a situation monitoring process to be described later.

The user information process adds, updates, and deletes the user information stored in the user information storage portion 321 of the database 32 based on requests from the terminal device 2.

The information provision process receives a schedule information request from the terminal device 2 and returns the schedule information stored in the schedule storage portion 322 to the terminal device 2 as a request origin. The schedule information is associated with a user specified by the user identification information indicated in the schedule information request. The schedule information request is transmitted in S11 in FIG. 3.

### 1-3-1 Schedule Setting Process

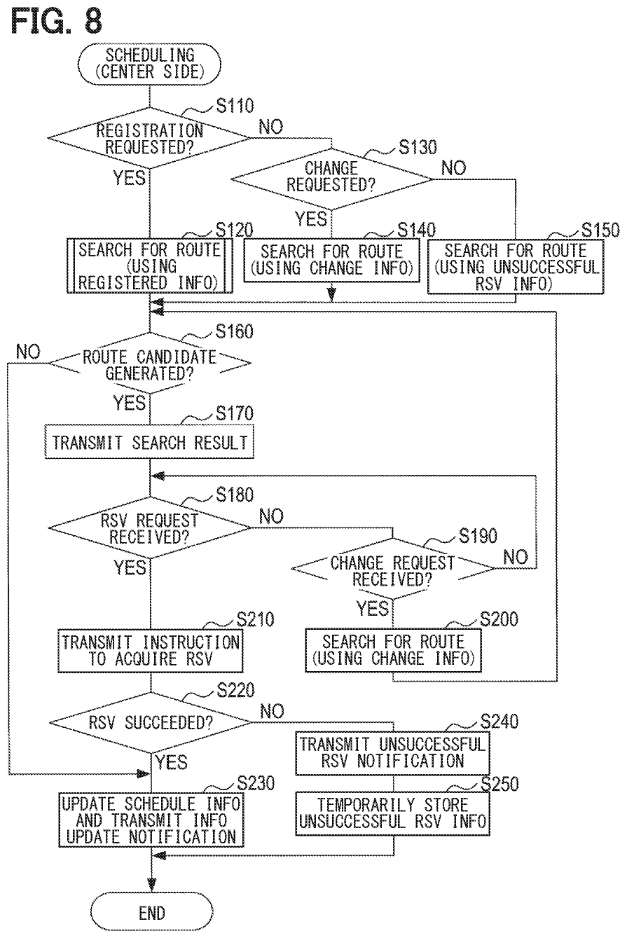

A schedule setting process performed by the center processing portion 34 will be described with reference to a flowchart in FIG. 8.

The schedule setting process starts when the registration request, the change request, or a re-search request is received from the terminal device 2. The registration request is transmitted in S14 in FIG. 3. The change request is transmitted in S17 in FIG. 3. The re-search request is transmitted in S26 in FIG. 3.

In S110, the center processing portion 34 determines whether the request received from the terminal device 2 corresponds to a new registration request regarding an unregistered event. If it is determined that the request from the terminal device 2 corresponds to the registration request, the center processing portion 34 advances the process to S120. If it is determined that the request from the terminal device 2 does not correspond to the registration request, the center processing portion 34 advances the process to S130.

In S120, the center processing portion 34 performs a route search based on the event information and the user identification information shown in the registration request and user information (target user information) stored in the user information storage portion 321 corresponding to the user identification information, and advances the process to S160. The route search uses the available transport method in the method information to generate multiple transfer routes (route candidates) from the departure place to the destination shown in the event information and extracts a specified number of route candidates compliant with the preference of a target user. The number of extracted route candidates may be configured as one of the user information, for example.

In S130, the center processing portion 34 determines whether the request from the terminal device 2 corresponds to the change request. If it is determined that the request from the terminal device 2 corresponds to the change request, the center processing portion 34 advances the process to S140, assuming that a re-search condition is satisfied. If it is determined that the request from the terminal device 2 does not correspond to the change request, the center processing portion 34 advances the process to S150, assuming that the re-search request is issued for the unsuccessful reservation.

In S140, the center processing portion 34 performs the route search based on the change information shown in the change request and the target user information and advances the process to S160. This route search is similar to the route search in S120 except the use of the change information shown in the change request instead of the registered information.

In S150, the center processing portion 34 performs the route search based on unsuccessful reservation information stored in S250 described later and the target user information and advances the process to S160. The route search here excludes the unsuccessfully reserved transport method or changes the scheduled time based on the unsuccessful reservation information and performs the process similar to the route search in S120.

When the departure place is the same as the destination in the registration request in S120, S140, S150, and S200 to be described and the contents of the change in the change request are unrelated to routes, the route search is omitted and no route candidate is generated.

In S160, the center processing portion 34 determines whether the route search generates a route candidate. If it is determined that a route candidate is generated, the center processing portion 34 advances the process to S170. If it is determined that no route candidate is generated, the center processing portion 34 advances the process to S230.

In S170, the center processing portion 34 returns multiple route candidates resulting from the route search to the terminal device 2 as an origin of transmission of the request.

In S180, the center processing portion 34 determines whether a reservation request is received from the terminal device 2. If it is determined that a reservation request is received, the center processing portion 34 advances the process to S210. If it is determined that no reservation request is received, the center processing portion 34 advances the process to S190. The reservation request is transmitted in S23 in FIG. 3.

In S190, the center processing portion 34 determines whether the change request is received from the terminal device 2. If it is determined that the change request is received, the center processing portion 34 advances the process to S200. If it is determined that no change request is received, the center processing portion 34 returns the process to S180. The change request here is transmitted in S22 in FIG. 3.

In S200, the center processing portion 34 performs a route search based on the change information shown in the change request and the target user information and returns the process to S160. The route search here is similar to the route search in S140.

In S210, the center processing portion 34 transmits an instruction to the reservation acquisition portion 33 based on the contents of the selected route shown in the reservation request. The instruction is to acquire the reservation regarding the transport method needed to be reserved. When receiving a response from the reservation acquisition portion 33, the center processing portion 34 advances the process to S220.

In S220, the center processing portion 34 determines whether the reservation succeeds based on the contents of the response from the reservation acquisition portion 33. If it is determined that the reservation succeeds, the center processing portion 34 advances the process to S230. If it is determined that the reservation fails, the center processing portion 34 advances the process to S240.

In S230, the center processing portion 34 updates the schedule information stored in the schedule storage portion 322 based on the contents of the event added or changed according to the registration request or the change request and the transfer route to the place where the event is held. Moreover, the center processing portion 34 transmits an information update notification along with the updated contents to the terminal device 2 and ends the process. The information update notification shows that the schedule information is updated.

In S240, the center processing portion 34 responds to the reservation request by transmitting an unsuccessful reservation notification showing that the reservation fails.

In S250, the center processing portion 34 temporarily stores the unsuccessful reservation information and ends the process. The unsuccessful reservation information contains at least information to specify the transport method that failed in the reservation. The temporary storage signifies that the storage is maintained only during the predetermined permissible time. When route search button Bd is re-pressed within the permissible time on the terminal device 2 that receives the unsuccessful reservation notification, the route search is performed by using the unsuccessful reservation information in S150 of the process when restarted.

In the schedule setting process, the processes in S120, S140, S150, and S200 correspond to a route search portion. The center processing portion 34 may correspond to the route search portion.

### 1-3-2 Reservation Monitoring Process

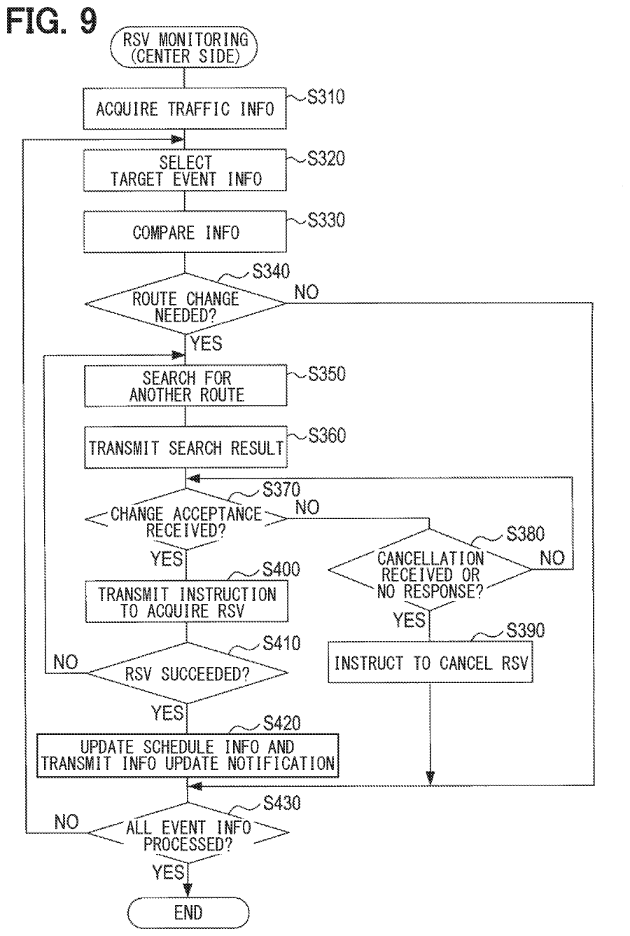

A reservation monitoring process performed by the center processing portion 34 will be described with reference to a flowchart in FIG. 9.

The reservation monitoring process is periodically performed at a predetermined time interval.

In S310, the center processing portion 34 allows the communication portion 31 to acquire traffic information from a server on an external network. The traffic information concerns the transport method used for the schedule management system 1. The traffic information contains situations such as traffic congestion, traffic regulation, train operation, carsharing availability, parking place availability, for example.

In S320, the center processing portion 34 selects target event information, namely, one of the pieces of event information from the schedule information.

In S330, the center processing portion 34 compares the traffic information acquired in S310 with the transfer route stored together with the target event information.

In S340, the center processing portion 34 determines whether a route change is needed based on a result of the comparison in S330. If it is determined that the route change is needed, the center processing portion 34 assumes the re-search condition to be satisfied and advances the process to S350. If it is determined that the route change is unneeded, the center processing portion 34 advances the process to S430.

In S350, the center processing portion 34 searches for another route in consideration of the traffic information for the transfer route determined to require the route change. If a railroad is unavailable, for example, the center processing portion 34 sets a route using another railroad or a route using vehicles (such as carsharing, bus, cab, and private car) instead of the railroad. When a vehicle is used as the transport method, the center processing portion 34 sets a route to avoid a congested road or a route using a railroad. The search for another route may be one or more routes.

In S360, the center processing portion 34 transmits the search result in S350 to a terminal device (target terminal device) 2 of the user who registered the target event information.

In S370, the center processing portion 34 determines whether a change acceptance is received as a response from the target terminal device 2. If it is determined that the change acceptance is received, the center processing portion 34 advances the process to S400. If it is determined that the change acceptance is not received, the center processing portion 34 advances the process to S380. When multiple other routes are transmitted as a route search result, the change acceptance contains information about which of the other routes needs to be selected.

In S380, the center processing portion 34 determines whether cancellation is received as a response from the target terminal device 2 or the permissible time expires with no response from the target terminal device 2 after the search result is transmitted. If it is determined that cancellation is received or no response returns, the center processing portion 34 advances the process to S390. If it is not determined that cancellation is received or no response returns, the center processing portion 34 returns the process to S370.

In S390, the center processing portion 34 removes the target event information selected in S320 from the schedule storage portion 322, instructs the reservation acquisition portion 33 to cancel the reservation of the target event information, and proceeds to S430.

In S400, the center processing portion 34 transmits an instruction to the reservation acquisition portion 33 in accordance with the change acceptance from the target terminal device 2. The instruction is to acquire the reservation of the transport method for the other accepted route. When accepting response from the reservation acquisition portion 33, the center processing portion 34 advances the process to S410. The center processing portion 34 reserves another route and concurrently cancels the reservation of the route before the change.

In S410, the center processing portion 34 determines whether the reservation succeeds based on the contents of the response from the reservation acquisition portion 33. If it is determined that the reservation succeeds, the center processing portion 34 advances the process to S420. If it is determined that the reservation fails, the center processing portion 34 returns the process to S350. In S350, the center processing portion 34 searches for another route except the transport method that failed in the reservation.

In S420, the center processing portion 34 updates the schedule information stored in the schedule storage portion 322 based on the other route compliant with the change acceptance. Moreover, the center processing portion 34 transmits the information update notification along with the updated contents to the target terminal device 2 and advances the process to S430. The information update notification shows that the schedule information is updated.

In S430, the center processing portion 34 determines whether the process in S320 to S420 is performed on all the event information contained in the schedule information stored in the schedule storage portion 322. If it is determined that the process is performed on all the event information, the center processing portion 34 ends the reservation monitoring process. If it is determined that unprocessed event information remains, the center processing portion 34 returns the process to S320 and continues the process on the unprocessed event information.

The reservation monitoring process includes a situation acquisition portion in S310 and a re-execution portion in S320 to S430.

### 1-4 System Operations

Operations of the schedule management system 1 will be described.

When the user manipulates the terminal device 2 to acquire his or her schedule information from the center device 3, the monitor of the terminal device 2 displays a schedule table illustrated in FIG. 4.

To register a new event, the user displays an input screen illustrated in FIG. 5 and takes the new-entry action. To change a registered event, the user specifies the event to be changed in the schedule table to display the event screen illustrated in FIG. 6, and takes the change-entry action.

The center device 3 performs the route search when the user takes the new-entry action or the change-entry action by using the terminal device 2. As shown in FIG. 7, the monitor of the terminal device 2 displays the candidate provision screen containing multiple route candidates as a search result. When a newly entered event is held in the company as the destination, however, the route search is not performed and the event is directly registered as the schedule information.

When the route candidates do not contain a route candidate the user wishes, and the user uses the terminal device 2 to take the change-entry action to change the condition of the transport method, for example, the center device 3 performs the route search under the changed condition and the monitor of the terminal device 2 displays the candidate provision screen.

When the route candidates contain a route candidate the user wishes, and the user uses the terminal device 2 to select one of the route candidates, the center device 3 acquires the reservation of the route candidate. When the reservation succeeds, the event registration ends.

When the reservation fails, the user may use the terminal device 2 to take action to request a re-search within the permissible time. Then, the center device 3 performs the re-search by excluding the route corresponding to the unsuccessful reservation. The monitor of the terminal device 2 displays the candidate provision screen.

Next, a case that requires the route change depending on a change in traffic situations will be described.

When the center device 3 detects a situation requiring the route change, another route is searched and a search result is displayed on the monitor of the terminal device 2 of the corresponding user. The terminal device 2 may display one search result that completes the reservation. Alternatively, the terminal device 2 may display multiple route candidates and allow the user to select one of the route candidates.

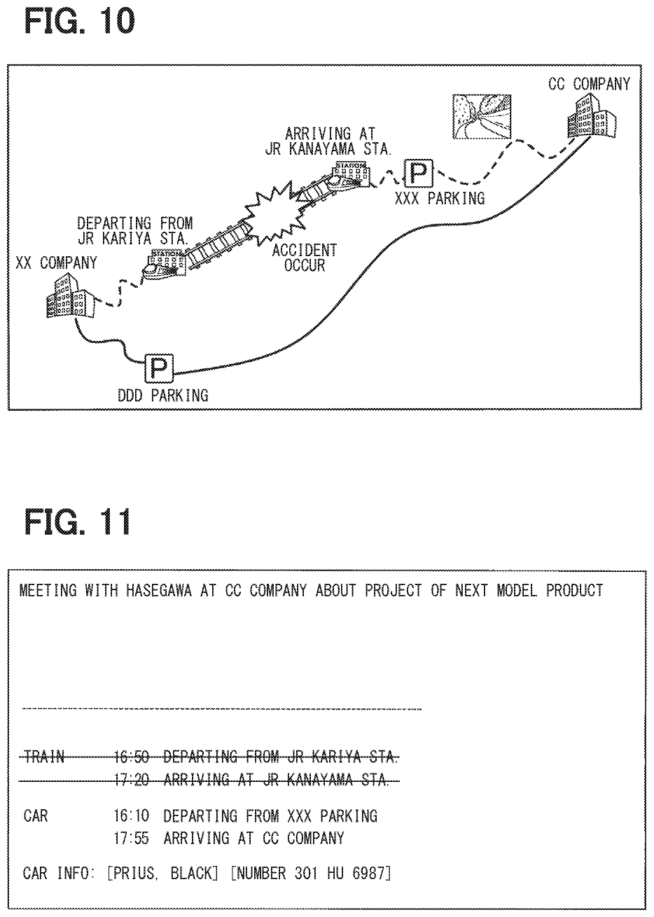

The terminal device 2 displays a result of searching for another route in a form that allows the user to easily understand a result of the route change having been performed. For example, as shown in FIG. 10, the simplified map displays routes before and after the change. Besides, a mark indicating unavailability of the transport method that caused the change may be overlaid. In a text format as shown in FIG. 11, for example, the terminal device 2 may display the text regarding the route after the change and the strike-through text regarding the route before the change.

### 1-5 Effects

The first embodiment described in detail above provides the following effects.

(1a) When the terminal device 2 is used to schedule an event in the schedule management system 1, the center device 3 searches for the transfer route to the destination of the event by using the user information stored in the user information storage portion 321. Particularly, the user information to be used is the method information representing the transport method available for the user as a request origin. Therefore, the schedule management system 1 can easily set an appropriate transfer route to the destination without necessitating the user to worry about available transport methods.

(1b) According to the schedule management system 1, the center device 3 allows the terminal device 2 to provide the user with multiple route candidates as a result of the route search. When the user selects a route candidate, the selected route is automatically reserved. Therefore, the schedule management system 1 can reduce user effort of reserving a transport method, for example.

(1c) According to the schedule management system 1, the center device 3 extracts multiple route candidates to be provided for the user by narrowing based on the narrowing information shown in the user information. Therefore, the schedule management system 1 can provide route candidates suited for user preference.

(1d) According to the schedule management system 1, the center device 3 periodically monitors traffic situations. When the situation necessitates a route change, the center device 3 automatically searches for another route and allows the terminal device 2 to propose another route to the user. When the user accepts the proposition, the center device 3 automatically performs the reservation. Therefore, the schedule management system 1 can promptly set an alternative route without annoying the user even if a trouble occurs on the transport method being used or to be used during transfer to the destination.

### 2. Second Embodiment

### 2-1 Differences from the First Embodiment

The basic configuration of a second embodiment is equal to that of the first embodiment. Differences will be described below. The same reference numerals as used for the first embodiment depict the same configuration. The preceding description will be referenced.

The above-described first embodiment performs the route search on respective events when anew event is added to the schedule. In contrast, the second embodiment differs from the first embodiment in that the route search is performed in consideration of the other registered events.

### 2-2 Route Search Process

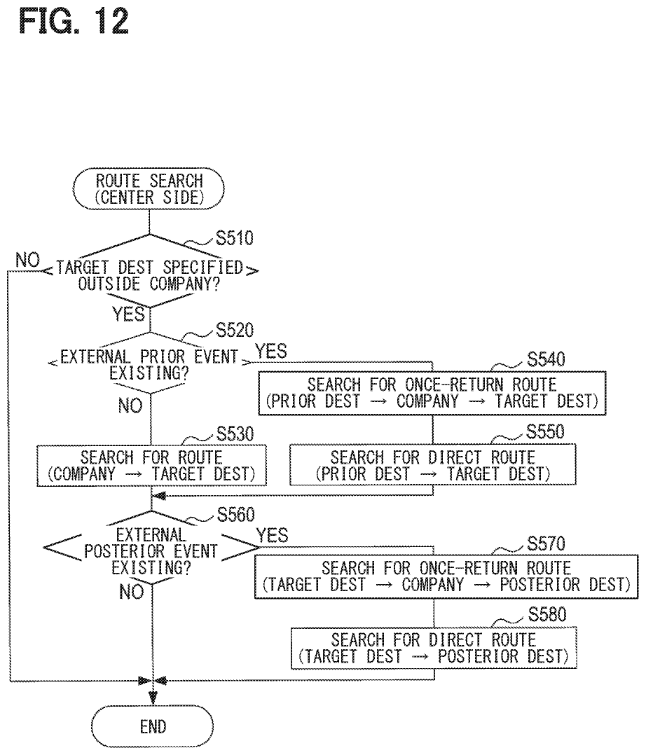

A route search process in which the center processing portion 34 performs in S130 according to the present embodiment will be described with reference to a flowchart in FIG. 12. When there occurs a request to change the event time, a process comparable to the process described below is also performed in S140, S150, S200, and S350.

In S510, the center processing portion 34 determines whether a target destination is specified outside the company. Note that the target destination is specified for a target event and the target event denotes an event shown in the registration request from the terminal device 2. If it is determined that the target destination is specified outside the company, the center processing portion 34 advances the process to S520. If it is determined that the target destination is specified within the company, the center processing portion 34 ends the process because there is no need to search for a route. In the drawings, a term of “DEST” corresponds to a term of “destination”.

In S520, the center processing portion 34 determines whether an external prior event exists. The external prior event is the last event already registered in the time period before the target event and specifies the destination outside the company. If it is determined that the external prior event does not exist, the center processing portion 34 advances the process to S530. If it is determined that the external prior event exists, the center processing portion 34 advances the process to S540.

In S530, the center processing portion 34 searches for a route to the target destination from the company and advances the process to S560.

In S540, the center processing portion 34 searches for a once-return route that allows a user to once return to the office from the destination (prior destination) of the external prior event and then go to the target destination anew.

In S550, the center processing portion 34 searches for a direct route going directly to the target destination from the prior destination and then advances the process to S560.

In S560, the center processing portion 34 determines whether an external posterior event exists. The external posterior event is the first event already registered in the time period after the target event and specifies the destination outside the company. If it is determined that the external posterior event does not exist, the center processing portion 34 ends the process. If it is determined that the external posterior event exists, the center processing portion 34 advances the process to S570.

In S570, the center processing portion 34 searches for a once-return route that allows a user to once return to the office from the target destination and then go to a destination (posterior destination) of an external posterior event anew.

In S580, the center processing portion 34 searches for a direct route going directly to the posterior destination from the target destination and then ends the process.

In a case where a target event is added, when an external prior event does not exist, as the route used for transference to the target event, only the route to the target destination from the company is searched. When an external prior event exists, the once-return route and the direct route are searched.

When the external posterior event exists, the once-return route and the direct route are searched as the routes used for transference to the external posterior event from the target event.

### 2-3 System Operations

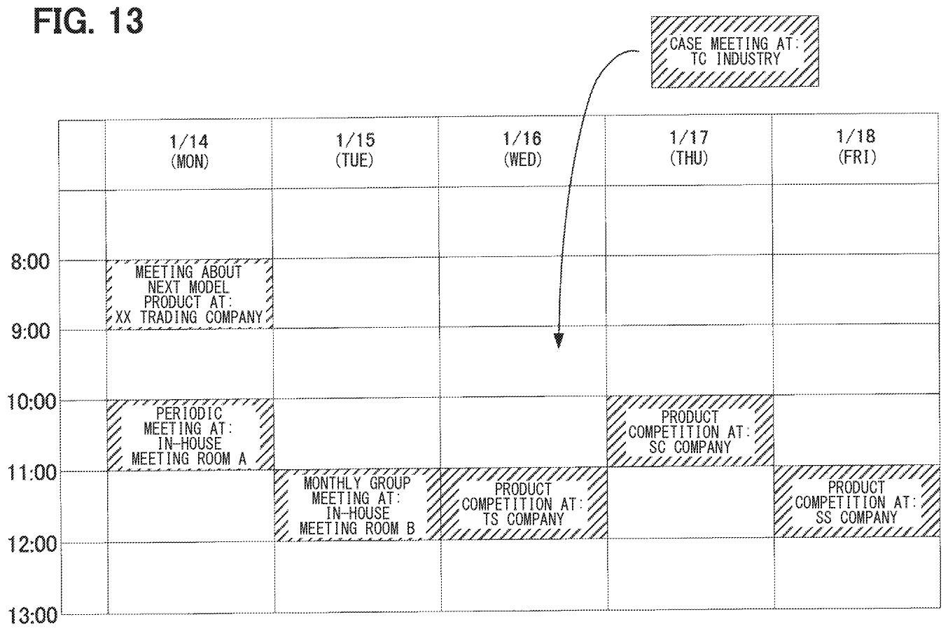

The registration of a new event before an already registered event will be described with reference to FIG. 13. It is assumed that the registered event (external posterior event) is scheduled at 11:00 through 12:00 on January 16 (Wednesday) and the new event (target event) is scheduled at 9:00 through 10:00 on January 16 (Wednesday). Both events specify destinations outside the company.

When the terminal device 2 is used to take the new-entry action to register a target event, the terminal device 2 displays a candidate provision screen similar to that described in the first embodiment for a route used to transfer to the target event.

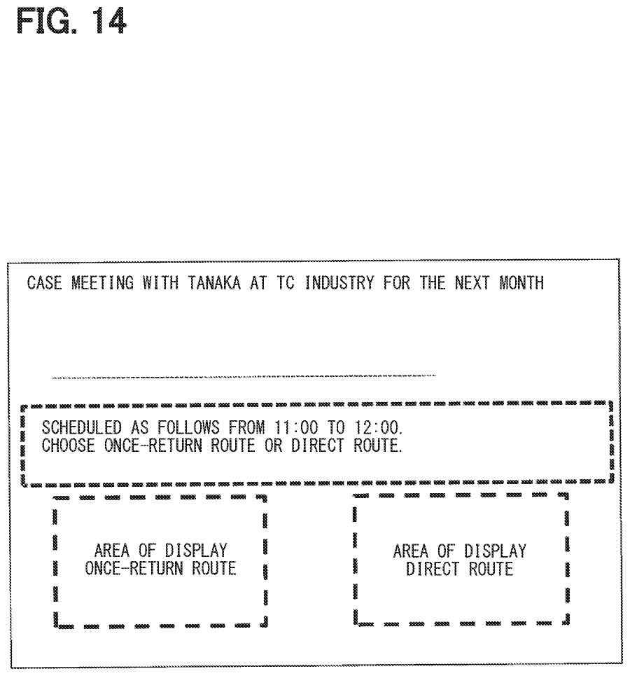

When the target event is added, it is necessary to allow the user to consider whether to change the transfer route to the external posterior event. As shown in FIG. 14, the monitor of the terminal device 2 displays the candidate provision screen including the once-return route and the direct route. The once-return route requires once returning to the office before transfer to the posterior destination from the target destination. The direct route requires directly going to the destination without returning to the office. One route candidate or multiple route candidates may be displayed for each of the once-return route and the direct route. The candidate provision screen may be configured to select the once-return route or the direct route. The multiple route candidates for the selected route may be displayed.

The description below includes the same contents as described in the first embodiment for the procedures to select an intended route from the route candidates displayed on the candidate provision screen or perform the re-search by changing the condition.

### 2-4 Effects

The second embodiment described in detail above provides the effects (1a) to (1d) described in the first embodiment and the following effect in addition.

(2a) The schedule management system 1 searches for the once-return route and the direct route and provides them for a user when other events are already registered before or after the target event. Therefore, the schedule management system 1 can reduce the user effort of re-examining the method of transferring to event destinations due to a change in the schedule.

### 3. Third Embodiment

### 3-1 Differences from the First Embodiment

The basic configuration of a third embodiment is equal to that of the first embodiment. Differences are described below. The same reference numerals as used for the first embodiment depict the same configuration. The preceding description will be referenced.

The above-described first embodiment adds or changes a schedule before starting the transfer based on the schedule. In contrast, the third embodiment differs from the first embodiment in the addition of a process that adds or changes a schedule in real time during the transfer based on the schedule.

### 3-2 Route Search Process

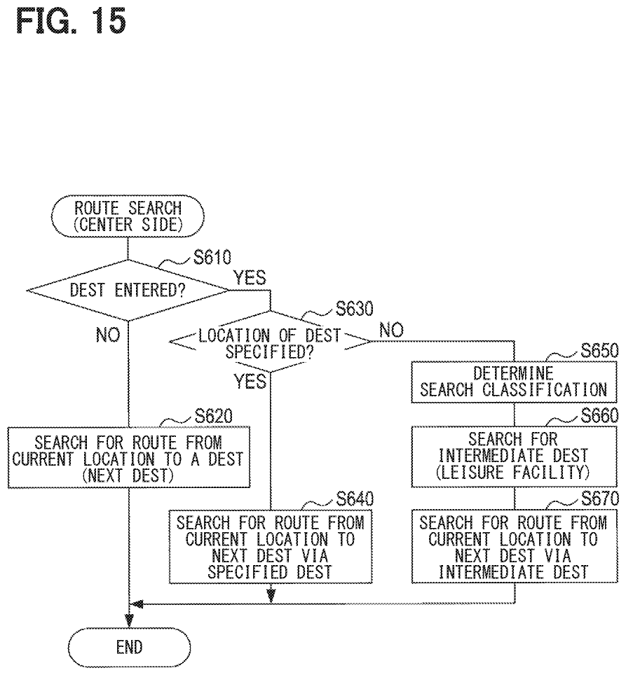

A route search process performed by the center device 3 according to the present embodiment will be described with reference to a flowchart in FIG. 15. The process is performed in S120 when the center device 3 receives a registration request containing the departure place as a current value from the terminal device 2.

In S610, the center processing portion 34 determines whether the registration request contains a destination as input. If it is determined that no destination is input, the center processing portion 34 advances the process to S620. If it is determined that a destination is input, the center processing portion 34 advances the process to S630.

In S620, the center processing portion 34 searches for a route from the current location to a destination (next destination) for the next event registered in the schedule and then ends the process.

In S630, the center processing portion 34 determines whether the destination shown in the registration request corresponds to the location of a leisure facility, for example. If it is determined that the location corresponds to a leisure facility or the like, the center processing portion 34 advances the process to S640. If it is determined that the location does not correspond to the leisure facility or the like, the center processing portion 34 advances the process to S650.

In S640, the center processing portion 34 searches for a route from the current location to the next destination via a stopover represented by the destination (such as the location of a leisure facility) specified in the registration request and then ends the process.

In S650, the center processing portion 34 determines the classification of the leisure facility as a search target according to the contents of the destination shown in the registration request. Specifically, when the classification of the leisure facility is explicitly stated, this classification is used. Meanwhile, when the search specifies only the request to search for the leisure facility as a destination but the classification of the leisure facility is not explicitly stated, the classification of the leisure facility is determined according to the target user's preference information registered in the user information.

In S660, the center processing portion 34 sets a search range based on the current location and the next destination shown in the registration request and searches for an intermediate destination represented by the leisure facility that belongs to the search range and is included in the classification determined in S650.

In S670, the center processing portion 34 searches for a route from the current location to the next destination by using the intermediate destination as a stopover searched in S660 and then ends the process. Search results are narrowed mainly in consideration of the current time, the time required to transfer from the current location to the intermediate destination, the shortest time to stay at the intermediate destination, the time required to transfer from the intermediate destination to the next event destination, and the time to start the next event.

### 3-3 System Operations

A situation where an event ends earlier than scheduled and the idle time occurs until the time to start the next scheduled event is assumed.

In a case where the user intends to make a side trip by using the idle time until the next event, if there is a specific place that the user intends to visit, the terminal device 2 transmits the registration request to the center device 3 so that the registration request specifies that place as a destination and the current location as the departure place. Then, the center device 3 performs the route search from the current location to the next destination by using the specified destination as a stopover. The monitor of the terminal device 2 displays multiple route candidates as a search result. The subsequent operation is equal to that described in the first embodiment.

In a case where there is no specific place that the user intends to visit but there is an intention to take a meal, the terminal device 2 transmits the registration request to the center device 3 so that the registration request specifies the classification of the leisure facility corresponding to the intention as the destination and the current location as the departure place. Then, the center device 3 searches for the leisure facility corresponding to the intention and performs the route search from the current location to the next destination by using the retrieved leisure facility as a stopover. The monitor of the terminal device 2 displays multiple route candidates as a search result. The subsequent operation is equal to that described in the first embodiment.

When there is no intention to do something, the terminal device 2 transmits the registration request to the center device 3 so that the registration request specifies the search for a leisure facility as the destination and the current location as the departure place. Then, the center device 3 searches for the leisure facility corresponding to the user preference based on the registered user information and performs the route search from the current location to the next destination by using the searched leisure facility as a stopover. The monitor of the terminal device 2 displays multiple route candidates as a search result. The subsequent operation is equal to that described in the first embodiment.

There may be a case where the user transfers to a location outside the transfer route bound for the next destination for some reason after the ending of the previous event and needs to re-configure the transfer route to the next destination. In such a case, the terminal device 2 transmits the registration request to the center device 3 so that the registration request specifies the departure place as the current location and the no destination as input. Then, the center device 3 performs the route search from the current location to the next destination. The monitor of the terminal device 2 displays multiple route candidates as a search result. The subsequent operation is equal to that described in the first embodiment.

### 3-4 Effects

The third embodiment described in detail above provides the effects (1a) to (1d) described in the first embodiment and the following effect in addition.

(3a) The schedule management system 1 can flexibly add a schedule or change the route based on not only the behavior according to the registered schedule but also user needs depending on the schedule progress without annoying the user.

### 4. Fourth Embodiment

### 4-1 Differences from the First Embodiment

The basic configuration of the fourth embodiment is equal to that of the first embodiment. Differences will be described below. The same reference numerals as used for the first embodiment depict the same configuration. The preceding description will be referenced.

The above-described first embodiment uses the terminal device 2 available as a commonly used mobile terminal such as a smartphone or a tablet computer. In contrast, the fourth embodiment describes a process using the terminal device 2 mounted integrally with a private car or a shared car or the terminal device 2 capable of acquiring the information to determine vehicle situations by communicating with the private car or the shared car.

### 4-2 Process

Here, an example of the process to change the schedule for the user's own reason will be described. The process copes with abnormalities on a reserved shared car the user uses to move to the next destination in accordance with the schedule. The shared card will be hereinafter simply described as a vehicle.

### 4-2-1 Terminal-Side Process

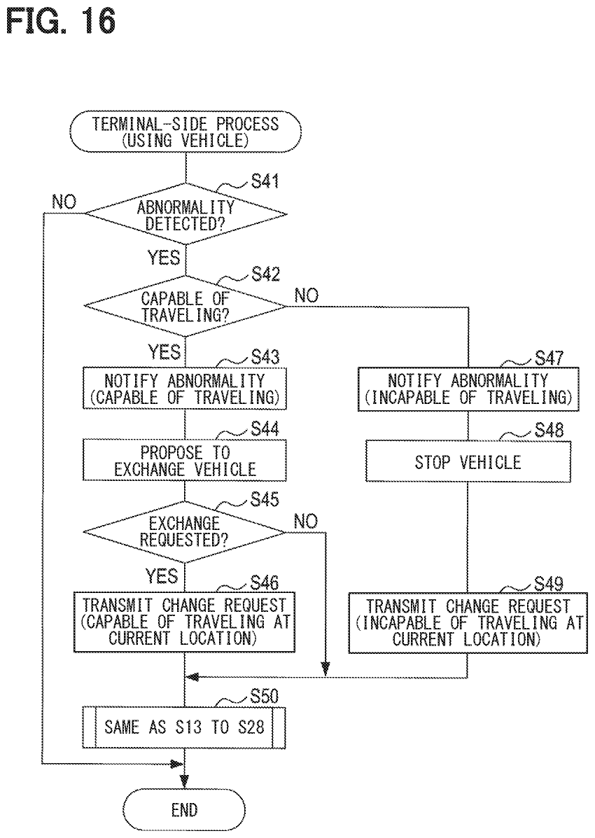

A terminal-side process performed by the terminal processing portion 23 of the terminal device 2 will be described with reference to a flowchart in FIG. 16. The terminal-side process is repeatedly performed at a predetermined cycle.

In S41, the terminal processing portion 23 acquires information representing vehicle states and, based on the information, determines whether an abnormality occurs on the vehicle. If it is determined that the abnormality occurs on the vehicle, the terminal processing portion 23 advances the process to S42. If it is determined that the vehicle is normal, the terminal processing portion 23 ends the process.

In S42, based on the contents of the detected abnormality, the terminal processing portion 23 determines whether the vehicle can continue traveling. If it is determined that the vehicle can continue traveling, the terminal processing portion 23 advances the process to S43. If it is determined that the vehicle cannot continue traveling, the terminal processing portion 23 advances the process to S47.

In S43, the terminal processing portion 23 allows the HMI portion 21 to notify a vehicle occupant that the abnormality occurs on the vehicle but the vehicle can continue traveling.

In S44, the terminal processing portion 23 allows the HMI portion 21 to notify proposition to exchange the vehicle.

In S45, the terminal processing portion 23 allows the HMI portion 21 to determine whether an exchange request to exchange the vehicle is input within the predetermined permissible time after the proposition is notified. If it is determined that the exchange request is input, the terminal processing portion 23 advances the process to S46. If it is determined that no exchange request is input, the terminal processing portion 23 advances the process to S50.

In S46, the terminal processing portion 23 transmits an abnormal-state change request to the center device 3 to request to exchange the vehicle although the vehicle can continue traveling. Then, the terminal processing portion 23 advances the process to S50.

Namely, the schedule management system 1 performs the normal process when the user does not request to exchange the vehicle despite the vehicle abnormality. By contrast, when the user requests to exchange the vehicle, the center device 3 searches for a route to the next destination including a shop as a stopover capable of exchanging the vehicle. The terminal device 2 provides the user with multiple route candidates as a search result.

In S47, the terminal processing portion 23 allows the HMI portion 21 to notify the vehicle occupant that the abnormality occurs on the vehicle and the vehicle cannot travel.

In S48, the terminal processing portion 23 forces the vehicle to travel in a retreat mode that searches the vehicle at a safe place and stops the vehicle at the safe place.

In S49, the terminal processing portion 23 transmits the abnormal-state change request to the center device 3 to notify that the vehicle cannot travel. Then, the terminal processing portion 23 advances the process to S50.

In response to the abnormal-state change request, the center device 3 searches for a route to the next destination including a method of moving to an alternative transport method from the current location. The terminal device 2 provides the user with multiple route candidates as a search result.

In S50, the terminal processing portion 23 performs the process in S13 to S28. When the user selects one of the route candidates, the center device 3 reserves the transport method regarding the selected route, for example.

### 4-2-2 Center-Side Process

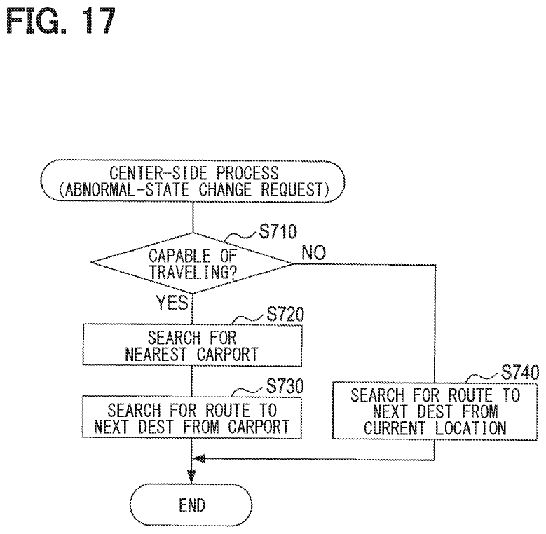

Next, a center-side process performed by the center processing portion 34 of the center device 3 will be described with reference to a flowchart in FIG. 17. The center-side process starts when the abnormal-state change request is received from the terminal device 2.

In S710, the center processing portion 34 determines whether a vehicle (requesting vehicle) mounted with the terminal device 2 as a request origin can travel, based on the information contained in the received abnormal-state change request. If it is determined that the requesting vehicle can travel, the center processing portion 34 advances the process to S720. If it is determined that the requesting vehicle cannot travel, the center processing portion 34 advances the process to S740.

In S720, the center processing portion 34 searches for the nearest carport capable of exchanging the vehicle based on the current location of the requesting vehicle shown in the abnormal-state change request.

In S730, the center processing portion 34 searches for a transfer route to the next destination including the searched carport as the stopover and then ends the process.

In S740, the center processing portion 34 searches for a transfer route to the next destination from the current location of the requesting vehicle shown in the abnormal-state change request on condition of the abnormal situation, and ends the process. In the abnormal situation, a transfer route including the use of cabs is searched for even a user who is inhibited to use cabs in normal situations. For example, it is possible to set a route using a cab to move from the current location to a place capable of using the nearest transport method when there are no other transport methods within a range capable of moving by foot from the current location of the requesting vehicle.

### 4-3 Effects

The fourth embodiment described in detail above provides the effects (1a) to (1d) described in the first embodiment and the following effect in addition.

(4a) The schedule management system 1 can propose and provide an alternative transport method without annoying the user even when the malfunctions occur on the vehicle that is used as scheduled.

### 5. Other Embodiments

While there have been described the embodiments of the present disclosure, the present disclosure is not limited to the above-described embodiments but may be otherwise variously modified.

(5a) The above-described embodiments provide an available transport method for each user and increase a transport method available to an abnormal situation. However, the present disclosure is not limited thereto. For example, settings of available transport methods may vary with meeting priorities. A normally disallowed transport method (such as a cab) may be allowed for the only one participant in the meeting comprised of no other participants or a responsible person for the meeting.

(5b) The terminal processing portion 23, the center processing portion 34, and their techniques described in the present disclosure may be embodied by a dedicated computer including a memory and a processor that is programmed to execute one or more functions implemented by a computer program. The terminal processing portion 23, the center processing portion 34, and their techniques described in the present disclosure may be embodied by a dedicated computer including a processor comprised of one or more dedicated hardware logic circuits. The terminal processing portion 23, the center processing portion 34, and their techniques described in the present disclosure may be embodied by one or more dedicated computers each configured as a combination of a processor programmed to execute one or more functions and a processor comprised of a memory and one or more hardware logic circuits. The computer program as an instruction executed by the computer may be stored in a computer-readable non-transitory tangible storage medium. The software is not needed to be inevitably included in the technique to implement functions of the portions included in the terminal processing portion 23 and the center processing portion 34. All the functions may be implemented through the use of one or more hardware products.

(5c) Multiple functions of one element in the above embodiment may be implemented by multiple elements, or one function of one element may be implemented by multiple elements. Further, multiple functions of multiple elements may be implemented by one element, or one function implemented by multiple elements may be implemented by one element. In addition, a part of the configuration of the described above embodiment may be omitted. At least a part of the configuration of the above embodiments may be added to or replaced with another configuration of the above embodiments.

(5d) The present disclosure may be variously embodied as not only the above-described schedule management system but also a program allowing a computer to function as the schedule management system or a non-transitory tangible storage medium such as a semiconductor memory that stores the program.

Here, the process of the flowchart or the flowchart described in this application includes multiple sections (or steps), and each section is expressed as, for example, S11. Further, each section may be divided into several subsections, while several sections may be combined into one section. Furthermore, each section thus configured may be referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

1. A schedule management system comprising:
a user information storage portion that stores user information corresponding to identification information to identify a user, wherein the user information includes method information showing an available transport method among a plurality of transport methods prepared in advance;
a request acquisition portion configured to acquire event information and the identification information, wherein the event information includes a departure place, a destination, and a time to arrive at the destination;
a route search portion configured to generate one or more route candidates by performing a route search using the available transport method in the user information stored in the user information storage portion in accordance with the event information and the identification information acquired by the request acquisition portion; and
a result provision portion configured to provide a search result from the route search portion.

2. The schedule management system according to claim 1, further comprising:
a selection portion configured to acquire a selected route selected from the one or more route candidates generated in the route search portion; and
a schedule storage portion that stores, as a part of schedule information, the event information acquired by the request acquisition portion and the selected route acquired by the selection portion.

3. The schedule management system according to claim 2, further comprising:
a reservation acquisition portion configured to acquire a reservation needed to implement transfer along the selected route selected by the selection portion,
wherein
the schedule storage portion stores, as the part of the schedule information, contents of the reservation acquired by the reservation acquisition portion.

4. The schedule management system according to claim 3, further comprising:
a re-execution portion configured to allow the route search portion to perform the route search regarding each of the schedule information stored in the schedule storage portion when a re-search condition set in advance is satisfied.

5. The schedule management system according to claim 4, further comprising:
a situation acquisition portion configured to acquire a situation of each of the plurality of transport methods,
wherein
the re-search condition includes a change in the situation of each of the plurality of transport methods.

6. The schedule management system according to claim 5, further comprising:
a change acquisition portion configured to acquire change information and a change request, wherein the change information shows the contents of a change in the event information contained in the schedule information stored in the schedule storage portion and the change request shows the identification information,
wherein
the re-search condition includes allowing the change acquisition portion to acquire the change request.

7. The schedule management system according to claim 6, wherein
the change information includes a change in at least one of the departure place, the destination, or the plurality of transport methods.

8. The schedule management system according to claim 4, further comprising:
a change acquisition portion configured to acquire change information and a change request, wherein the change information shows the contents of a change in the event information contained in the schedule information stored in the schedule storage portion and the change request shows the identification information,
wherein
the re-search condition includes allowing the change acquisition portion to acquire the change request.

9. The schedule management system according to claim 2, further comprising:
a re-execution portion configured to allow the route search portion to perform the route search regarding each of the schedule information stored in the schedule storage portion when a re-search condition set in advance is satisfied.

10. The schedule management system according to claim 9, further comprising:
a situation acquisition portion configured to acquire a situation of each of the plurality of transport methods,
wherein
the re-search condition includes a change in the situation of each of the plurality of transport methods.

11. The schedule management system according to claim 10, further comprising:
a change acquisition portion configured to acquire change information and a change request, wherein the change information shows the contents of a change in the event information contained in the schedule information stored in the schedule storage portion and the change request shows the identification information,
wherein
the re-search condition includes allowing the change acquisition portion to acquire the change request.

12. The schedule management system according to claim 11, wherein
the change information includes a change in at least one of the departure place, the destination, or the plurality of transport methods.

13. The schedule management system according to claim 9, further comprising:
a change acquisition portion configured to acquire change information and a change request, wherein the change information shows the contents of a change in the event information contained in the schedule information stored in the schedule storage portion and the change request shows the identification information,
wherein
the re-search condition includes allowing the change acquisition portion to acquire the change request.

14. The schedule management system according to claim 1, wherein
the plurality of transport methods include at least one of a private car, a shared car, or a rented car.

15. A schedule management system comprising:
one or more processors; and
a memory that
stores user information corresponding to identification information to identify a user, wherein the user information includes method information showing an available transport method among a plurality of transport methods prepared in advance, and
coupled to the one or more processors and storing program instructions that when executed by the one or more processors cause the one or more processors to at least:
acquire event information and the identification information, wherein the event information includes a departure place, a destination, and a time to arrive at the destination;
generate one or more route candidates by performing a route search using the available transport method in the user information in accordance with the event information and the acquired identification information; and
provide a search result from the route search portion.

16. A schedule management system comprising:
a terminal that includes
one or more first processors;
a first memory coupled to the one or more first processors and storing program instructions that when executed by the one or more first processors cause the one or more first processors to at least:
acquire event information and identification information to identify a user, wherein the event information includes a departure place, a destination, and a time to arrive at the destination;
a center that includes:
one or more second processors; and
a second memory that
stores user information corresponding to the identification information, wherein the user information includes method information showing an available transport method among a plurality of transport methods prepared in advance, and
coupled to the one or more second processors and storing program instructions that when executed by the one or more second processors cause the one or more second processors to at least:
generate one or more route candidates by performing a route search using the available transport method in the user information in accordance with the event information and the acquired identification information: and
transmit a search result obtained by the performed route search to the terminal device,
wherein
the terminal further includes a display device configured to display the search result.
